(19) United States
(12) Patent Application Publication
(10) Pub. No.: US 2018/0213585 A1
(43) Pub. Date: Jul. 26, 2018

(54) COMMUNICATION APPARATUS, COMMUNICATION METHOD, AND PROGRAM

(71) Applicant: CANON KABUSHIKI KAISHA, Tokyo (JP)

(72) Inventor: Kazuo Moritomo, Kawasaki-shi (JP)

(21) Appl. No.: 15/745,951

(22) PCT Filed: Jul. 13, 2016
(86) PCT No.: PCT/JP2016/003312

§ 371 Date: Jan. 18, 2018

(30) Foreign Application Priority Data
Jul. 21, 2015 (JP) 2015-144402

(51) Int. Cl. H04W 76/15; H04W 48/16

(52) U.S. Cl. CPC H04W 76/15; H04W 84/12; H04W 48/16

(57) ABSTRACT

A communication apparatus selects one of a first connection method and a second connection method, wherein the first connection method is a connection method in which a connection is made between the communication apparatus and a second different communication apparatus to acquire, from the second different communication apparatus, a communication parameter for use by an access point to create a wireless network, while the second connection method is a connection method in which a role determination process is performed. The communication apparatus displays on a display unit an image including information indicating the selected connection method. In a case where the first connection method is selected, the second different communication apparatus is searched for in a plurality of channels usable by the communication apparatus. In a case where the second connection method is selected, the second different communication apparatus is searched for in particular part of the plurality of channels.

### TECHNICAL FIELD

The present disclosure relates to a communication technique.

### BACKGROUND ART

In recent years, it has become popular to install a wireless communication function in an electronic device such as a digital camera, a printer, a portable telephone, a smartphone, etc., to make it possible for the device to be used in a state in which the device is connected to a wireless network.

To connect an electronic device to a wireless network, it is necessary to set various communication parameters in terms of an encryption method, an encryption key, an authentication method, an authentication key, and/or the like. PTL 1 discloses a technique for making it easy to set such communication parameters. In the technique disclosed in PTL 1, an electronic device displays a QR code (registered trademark) indicating communication parameters. A portable terminal reads the QR code by capturing an image of the QR code, and the portable terminal makes an access point set the read communication parameters.

Electronic devices may be connected directly to each other according to Wi-Fi Direct (registered trademark), which is a connection standard established by Wi-Fi Alliance to enable electronic devices to connect to each other. In wireless communication using a 2.4 GHz band using Wi-Fi Direct, an electronic device is searched for only in 1st, 6th, and 11th channels of all channels, which makes it possible to search for the electronic device in an efficient manner. By setting communication parameters in response to capturing an image of code information such as a two-dimensional code in which a large amount of information may be coded, it is possible to easily connect an electronic device to an access point, which allows a reduction in complexity of an input operation performed by a user.

According to the Wi-Fi Direct standard, setting of communication parameters is supposed to be performed via a communication parameter sharing process called WPS (Wi-Fi Protected Setup) defined by the Wi-Fi Alliance. However, in sharing communication parameters between apparatuses in the technique of connecting apparatuses according to Wi-Fi Direct or the like, no consideration is paid to a method of performing a communication parameter sharing process in response to capturing an image as with the technique disclosed in PTL 1.

In the technique of connecting apparatuses according to Wi-Fi Direct or the like, in a case where a communication parameter sharing process is performed between two apparatuses by using information indicated in a captured image as in the technique disclosed in PTL 1, a partner apparatus with which the communication parameters are to be shared is searched for in 1st, 6th, and 11th channels as described above. On the other hand, in a case where an apparatus that displays an image is connected to an access point using information represented in a captured image as with the technique disclosed in PTL 1, the apparatus that displays the image needs to perform searching over all channels to find the access point.

In a case where apparatuses are connected to each other using one of a plurality of different connection methods as described above, there is a possibility that it takes a long time to achieve the connection or there is even a possibility that it is impossible to correctly perform the connection unless the connection method is shared between the apparatuses.

For example, in order for an apparatus displaying an image to achieve a connection using Wi-Fi Direct, the apparatus displaying the image is supposed to search for a partner apparatus using 1st, 6th, and 11th channels. In this situation, if the apparatus displaying the image tries to connect itself to an access point that forms a wireless network in a channel different from any of the 1st, 6th, and 11th channels, the apparatus displaying the image is not capable of detecting the access point.

In order for an apparatus displaying an image to connect to an access point, the apparatus displaying the image is supposed to search for a partner apparatus using all channels. In this situation, if an apparatus that is to capture an image tries to connect the apparatus displaying the image to it using Wi-Fi Direct, the apparatus displaying the image needs to perform searching not only on 1st, 6th, and 11th channels but also on other channels. Thus unnecessary processing is performed, which results in an increase in time needed to achieve the connection.

In view of the above, the present disclosure provides a technique that allows it, in sharing communication parameters in response to capturing an image, to efficiently share a process to be performed between apparatuses and detect each apparatus.

### CITATION LIST

### Patent Literature

PTL 1: Japanese Patent Laid-Open No. 2014-60623

### SUMMARY OF INVENTION

In view of the above, the present disclosure provides a communication apparatus including a selection unit configured to select one of a first connection method and a second connection method, the first connection method being a connection method in which a connection is made between the communication apparatus and a second different communication apparatus to acquire from the second different communication apparatus a communication parameter for use by an access point to create a wireless network, the second connection method being a connection method in which a role determination process is performed to determine whether the communication apparatus is to operate as an creating apparatus that is to create a wireless network or as a joining apparatus that is to join a created wireless network, a display control unit configured to control a display unit to display an image including information indicating the connection method selected by the selection unit, and a search unit configured to search for the second different communication apparatus such that in a case where the first connection method is selected by the selection unit, the second different communication apparatus is searched for on a plurality of channels usable by the communication apparatus, while in a case where the second connection method is selected by the selection unit, the second different communication apparatus is searched for on particular part of the plurality of channels, wherein in the case where the first connection method is selected by the selection unit, the communication parameter for use by the access point to create the wireless network is acquired from the second different communication apparatus retrieved by the search unit, while in the case where the second connection method is selected by the selection unit, a communication parameter for wireless communication is shared between the communication apparatus and the second different communication apparatus retrieved by the search unit.

Further features of the present invention will become apparent from the following description of exemplary embodiments with reference to the attached drawings.

### BRIEF DESCRIPTION OF DRAWINGS

FIG. 1 is a diagram illustrating a configuration of a communication apparatus.

FIG. 2 is a diagram illustrating a software function configuration of a communication apparatus.

FIG. 3 is a diagram illustrating an example of a configuration of a communication system.

FIG. 4 is a flow chart illustrating an operation of a camera.

FIG. 5 is a diagram illustrating an example of a sequence performed in a communication system.

FIG. 6 is a flow chart illustrating an operation of a smartphone.

FIG. 7 is a diagram illustrating an example of a sequence performed in a communication system.

FIG. 8 is a diagram illustrating an example of a sequence performed in a communication system.

### DESCRIPTION OF EMBODIMENTS

A communication apparatus according to an embodiment is described in detail below with reference to drawings. In the following description, it is assumed by way of example that a wireless LAN system according to the IEEE (The Institute of Electrical and Electronics Engineers, Inc.) 802.11 standard is used. However, the communication method is not limited to the wireless LAN according to IEEE802.11.

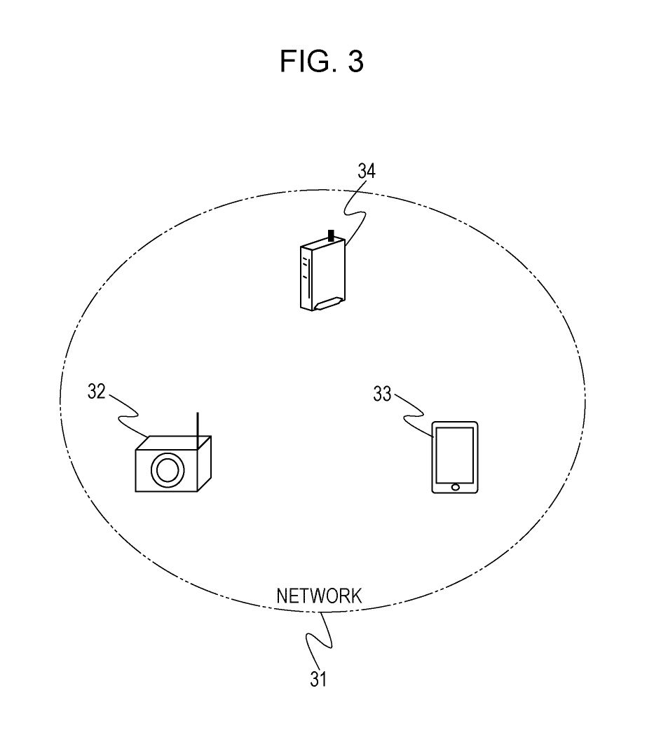

FIG. 3 illustrates a communication system according to the present embodiment. The communication system shown in FIG. 3 includes a camera 32, a management apparatus 33, and an access point (AP) 34. A wireless network 31 is a wireless LAN created by the AP 34 according to the IEEE802.11 series. The management apparatus 33 is a communication apparatus that manages communication parameters associated with the wireless network. The communication parameters may include a network identifier, network security information, and the like. Details of the communication parameters will be described later. In the communication system according to the present embodiment, the management apparatus 33 is by way of example a smartphone. However, the management apparatus 33 may be another type of communication apparatus such as a personal computer (PC), a smart watch, a personal digital assistant (PDA), or the like. Furthermore, in the communication system according to the present embodiment, the camera 32 is a user apparatus. However, the user apparatus may be another type of communication apparatus, such as a smartphone, a printer, a PC, a video camera, a smart watch, a PDA, or the like.

In the present embodiment, the AP 34 operates as an access point in an infrastructure mode defined in the IEEE802.11 standard. When another apparatus is connected to the AP 34, the apparatus operates as a station (STA) in the infrastructure mode defined in the IEEE802.11 standard.

The camera 32 and the management apparatus 33 (hereinafter referred to as the smartphone 33) are allowed to be connected to each other via a wireless LAN created by the camera 32 or the smartphone 33 according to the Wi-Fi Direct standard.

Wi-Fi Direct is a communication standard established by Wi-Fi Alliance and provides one of connection methods for wireless LAN connections. The Wi-Fi Direct standard defines a connection sequence including searching for a communication partner apparatus, forming a communication group with the retrieved partner apparatus, and performing a wireless LAN communication. In the Wi-Fi Direct standard, a communication apparatus operating as a wireless LAN access point is referred to as a P2P group owner (hereinafter referred to as a GO), and a communication apparatus operating as a wireless LAN station is referred to as a P2P client (hereafter referred to as a CL). That is, in Wi-Fi Direct, a GO is an creating apparatus that creates a wireless LAN, and a CL is a joining apparatus that joins the wireless LAN created by the GO. These roles are determined via a role determination process called GO Negotiation defined in the Wi-Fi Direct standard. Apparatuses play their determined roles in operation in wireless connection and wireless communication between the apparatuses. That is, in Wi-Fi Direct, a plurality of roles are defined, and a role determination process is performed to determine roles of respective apparatuses in communication.

Note that in Wi-Fi Direct a network created by a GO is called a P2P group. In the present description, a wireless network created by Wi-Fi Direct is also called a P2P group. Note that these two expressions are the same in meaning. In the present description, GOs, CLs, and communication apparatuses whose role is not determined are generically referred to as P2P devices. A P2P device is allowed to join a wireless network (CL function) and is also allowed to create a wireless network (GO function). In a case where apparatuses are connected to each other using Wi-Fi Direct, a GO provides communication parameters to a CL, and the connection is achieved using these communication parameters. The communication parameters include various wireless communication parameters for wireless communication according to the IEEE802.11 standard. That is, the communication parameters include wireless communication parameters such as a Service Set Identifier (SSID) serving as a network identifier, an encryption method, an encryption key, an authentication method, an authentication key, and the like necessary in performing wireless LAN communication. The communication parameters may include a MAC (Media Access Control) address, an IP (Internet Protocol) address for communication in an IP layer, or the like.

In Wi-Fi Direct, searching for a communication partner apparatus is performed while switching a Scan Phase and a Find Phase. In the Find Phase, the operation is performed while alternately switching a listen state and a search state at random time intervals. In a case where a communication apparatus performs a Wi-Fi Direct communication using a 2.4 GHz band, an AP or a GO is searched for in the Scan Phase while transmitting a search signal sequentially in all usable channels from a 1st channel to a 13th channel (different depending on the country). In the searching, instead of transmitting the search signal, a beacon transmitted from another apparatus may be detected. Thereafter, the operation goes to the Find Phase, in which the listen state and the search state are alternately switched. In the listen state, a search signal transmitted from a second different communication apparatus is awaited in one of 1st, 6th, and 11th channels of all channels, i.e., 1st to 13th channels. After the operation is performed for a predetermined period in the listen state, the operation is switched to the search state, in which a search signal is transmitted sequentially on only three channels, i.e., 1st, 6th, and 11th channels of all channels, i.e., 1st to 13th channels thereby searching for another communication apparatus operating in the listen state.

In Wi-Fi Direct, as described above, the search signal is not always transmitted over all channels, but only on part of all channels. This makes it possible to search for a communication partner apparatus in an efficient manner thereby reducing a time needed to search for the communication partner apparatus. As for the search signal, a Probe Request according to the IEEE802.11 standard or an Action Frame according to the IEEE802.11 standard may be used.

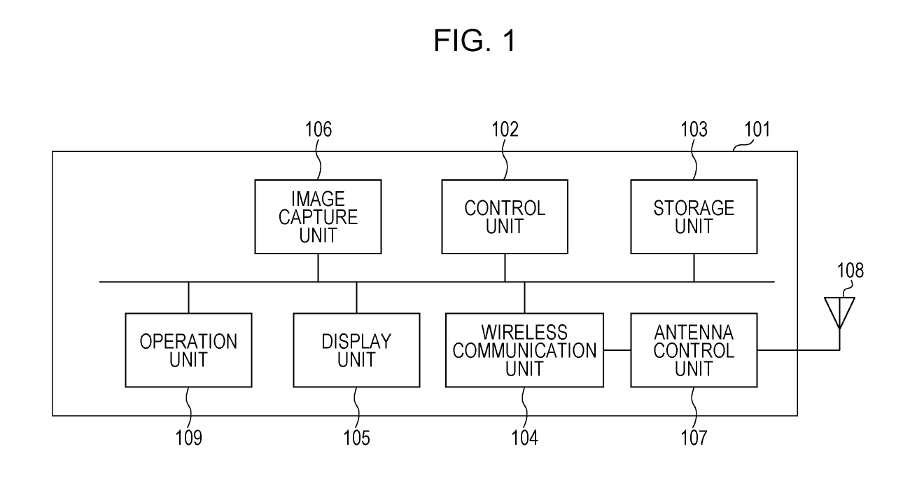

Next, a hardware configuration of each communication apparatus in the communication system shown in FIG. 3 is described below with reference to FIG. 1. In FIG. 3, 101 denotes the whole apparatus. A control unit 102 controls the whole apparatus by executing a control program stored in a storage unit 103. The control unit 102 may be realized, for example, by a central processing unit (CPU). The storage unit 103 stores the control program executed by the control unit 102, image data, and various kinds of information such as communication parameters. Various operations described below are performed by the control unit 102 by executing the control program stored in the storage unit 103. The storage unit 103 may be realized using storage medium such as a ROM, a RAM, an HDD, a flash memory, a removable SD card, or the like.

A wireless communication unit 104 is for performing a wireless LAN communication according to the IEEE802.11 series. The wireless communication unit 104 is realized using a chip configured to perform a wireless communication. A display unit 105 is for displaying various kinds of information. The display unit 105 has a function of outputting visually recognizable information using an LCD, an LED, or the like, and/or a function of outputting a voice/sound using a speaker or the like. The display unit 105 has a function of outputting at least one of visual information and voice/sound information. In a case where the display unit 105 displays visual information, the display unit 105 includes a video RAM (VRAM) for storing image data corresponding to visible information to be displayed. The display unit 105 controls displaying to continuously display the image data stored in the VRAM on the LCD or the LED.

An image capture unit 106 includes an image sensor, a lens, and the like and is configured to capture a still image or a moving image. The image capture unit 106 is capable of reading code information such as a barcode, a two-dimensional code such as a QR code, or the like.

An antenna control unit 107 is for controlling outputting of an antenna 108. The antenna 108 is configured to operate in 2.4 GHz band and/or 5 GHz band in wireless LAN communication. An operation unit 109 is used by a user to input various kinds of data/commands to control the communication apparatus 101. The operation unit 109 stores a flag associated with an input in a memory such as the storage unit 103 or the like.

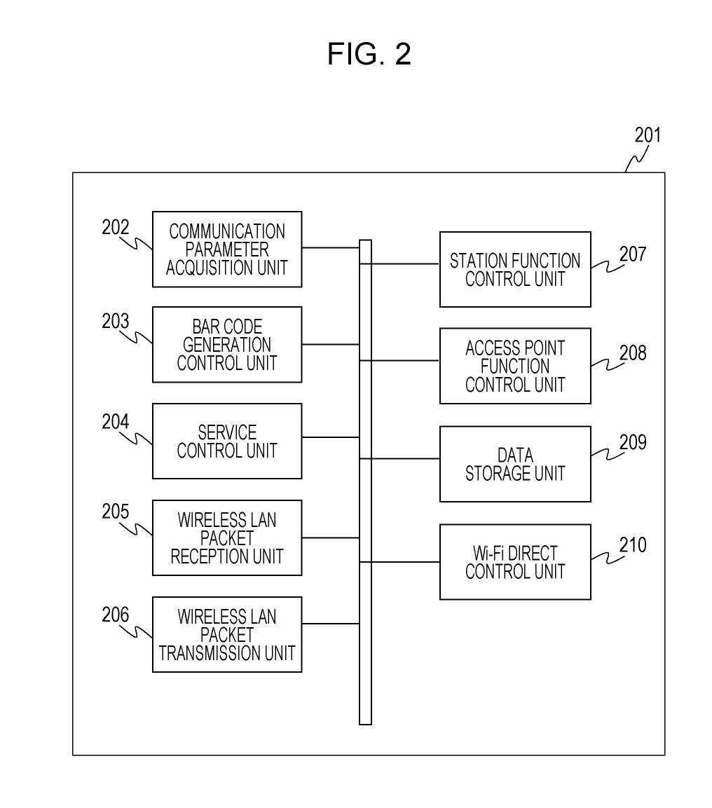

FIG. 2 is a block diagram illustrating an example of a configuration in terms of software functional blocks associated with communication control functions that are provided in each communication apparatus shown in FIG. 3. In the present embodiment, the functional blocks of each communication apparatus are respectively stored in the form of programs in the storage unit 103, and the functions thereof are realized by the control unit 102 by executing the programs. That is, the control unit 102 realizes the respective functions by controlling various pieces of hardware and performing operations or processing on information according to the control programs. Note that part or all of the functional blocks may be realized by hardware. In this case, part or all of the functional blocks may be realized, for example, by using an application specific integrated circuit (ASIC).

In FIG. 2, 201 denotes the whole software functional blocks. A communication parameter control unit 202 performs a communication parameter sharing process to share communication parameters between apparatuses. In the communication parameter sharing process, a providing apparatus provides a reception apparatus with communication parameters for wireless communication whereby the communication parameters are shared between the providing apparatus and the reception apparatus. The communication parameters include, as described above, wireless communication parameters such as an SSID as a network identifier, an encryption method, an encryption key, an authentication method, an authentication key, and/or the like necessary in performing a wireless LAN communication. The communication parameters may further include a MAC address, a path phrase, an IP address for communication in the IP layer, information necessary for upper service, and/or the like. The communication parameter sharing process executed by the communication parameter control unit 202 may be Wi-Fi Protected Setup (WPS) defined by the Wi-Fi Alliance. The communication parameter sharing process executed by the communication parameter control unit 202 may be performed such that the communication parameters are securely transmitted using a public key encryption technique.

A barcode generation control unit 203 performs control such that code information such as a barcode or a two-dimensional code such as a QR code or the like is generated and the generated code information is displayed on the display unit 105. More specifically, in the present embodiment, the barcode generation control unit 204 generates a QR code representing a coded information necessary in setting the communication parameters and displays the resultant QR code.

204 denotes a service control unit in an application layer. Herein, the application layer refers to a service providing layer in layers higher than a fifth layer in an OSI reference model. That is, the service control unit 204 performs a printing process, an image streaming process, a file transfer process, or the like using wireless communication by the wireless communication unit 104.

A wireless LAN packet reception unit 205 and a wireless LAN packet transmission unit 206 control reception or transmission of various packets including a communication protocol in the higher layer. A wireless LAN packet reception unit 205 and a wireless LAN packet transmission unit 206 control the wireless communication unit 104 to receive or transmit packets from or to an apparatus at an opposite end according to the IEEE802.11 standard.

A station function control unit 207 provides a STA function of operating as a station (STA) in an infrastructure mode defined in the IEEE802.11 standard. In the operation as an STA, the STA function control unit 207 performs an authentication/encryption process and the like. An access point function control unit 208 provides an AP function of operating as an access point (AP) in the infrastructure mode defined in the IEEE802.11 standard. The AP function control unit 208 creates a wireless network and performs processing including an authentication/encryption process on STA and performs STA management. A data storage unit 209 controls writing and reading data to or from the data storage unit 103. The data may include software itself, communication parameters, code information, or the like.

A Wi-Fi Direct control unit 210 performs various processes associated with Wi-Fi Direct described above. In a case where a communication apparatus operates as a GO, the Wi-Fi Direct control unit 210 controls the AP function control unit 208 such that the communication apparatus functions as an AP. In a case where the communication apparatus operates as a CL, the Wi-Fi Direct control unit 210 controls the STA function control unit 207 such that the communication apparatus functions as an STA.

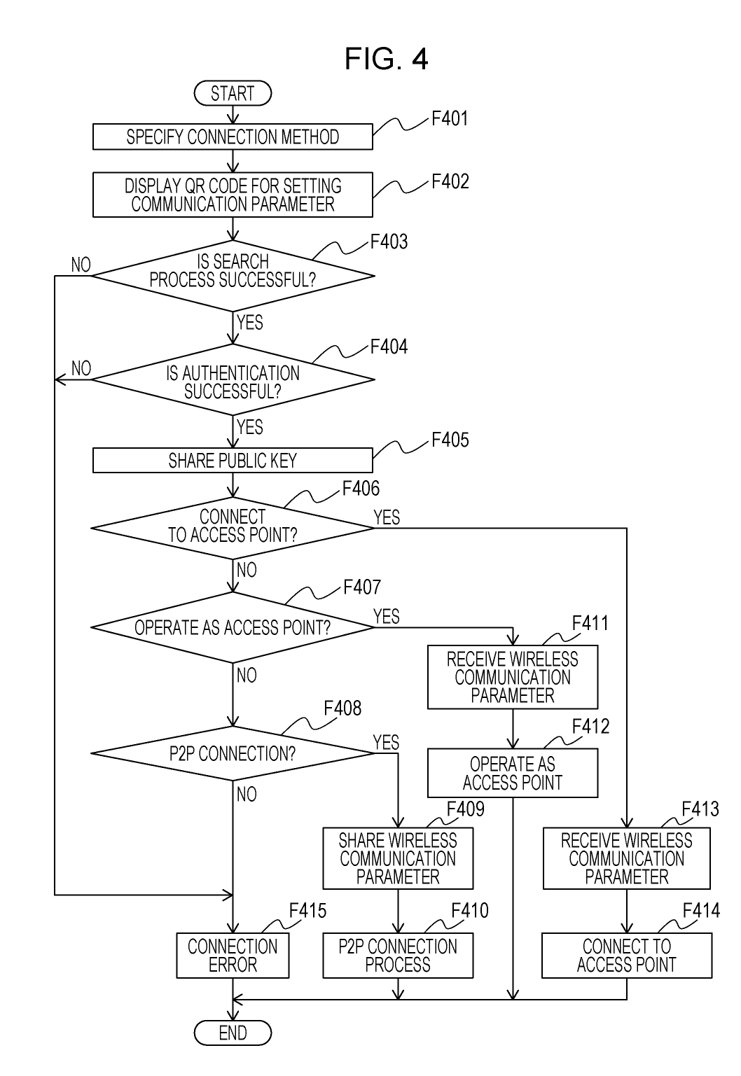

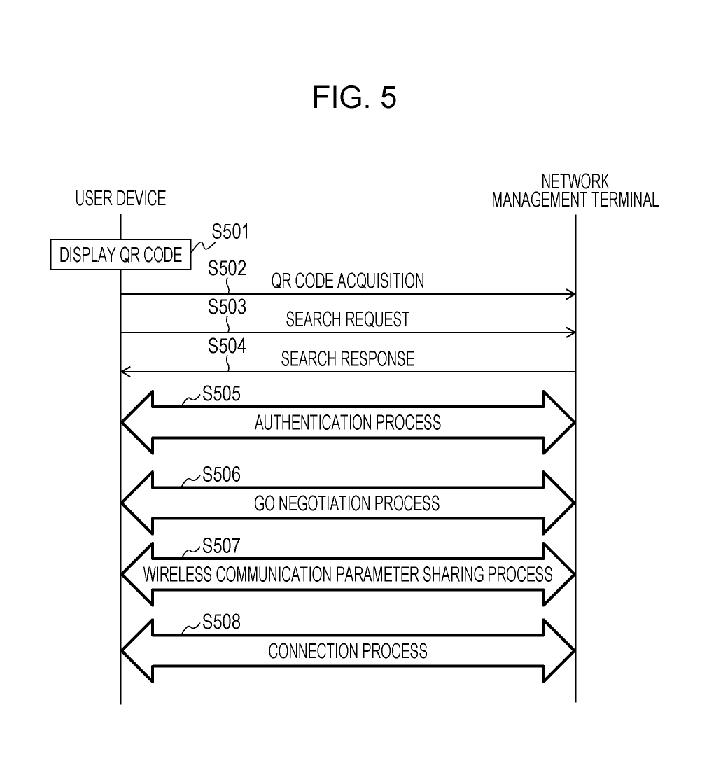

A description is given below as to an operation of the communication system configured in the above-described manner. As an example of the operation, it is assumed that an image of a QR code displayed by the camera 32 is captured by the smartphone 33, and a wireless connection between apparatuses is created using information obtained from the captured QR code. FIG. 5 illustrates a sequence of creating the Wi-Fi Direct connection using the QR code between the two communication apparatuses, that is, the camera 32 and the smartphone 33. In this specific example, it is assumed that an apparatus that displays the QR code sends a notification of a connection method to an apparatus that captures the image of the QR code. When a user selects a connection method on the camera 32 that displays the QR code, the camera 32 displays the QR code corresponding to the selected connection method. FIG. 4 is a flow chart illustrating a process that is performed by the camera 32 when the WiFi Direct is selected as the connection method. Steps of the flow chart are performed by the control unit 102 by executing a control program stored in the storage unit 103 of the camera 32.

When a communication parameter setting mode is started to execute the communication parameter sharing process, the camera 32 displays information to prompt a user to select a connection method. For example, a selection list of options including “Connect by Wi-Fi Direct”, “Connect to AP”, and “Operate as AP” is displayed such that a user is allowed to select one of them. In F401, the camera 32 accepts a connection method specified by the user. In F402, the camera 32 displays a QR code for a communication parameter sharing process on the display unit 105 (S501). The QR code displayed includes at least information indicating the connection method specified in F401. For example, in a case where Wi-Fi Direct is specified in F401 as the connection method, the camera 32 displays the QR code corresponding to the WiFi Direct on the Wi-Fi Direct. Note that the QR code corresponding to the Wi-Fi Direct refers to a QR code representing, in the coded form, information specifying Wi-Fi Direct. The QR code may include role information indicating a role in the Wi-Fi Direct communication. More specifically, for example, the QR code may include an intent value or the like used in a negotiation process to determine which apparatus is to operate as GO. Furthermore, the QR code corresponding to the Wi-Fi Direct may include attribute information of a communication apparatus (a camera, a printer, a display, or the like) or information indicating services available (streaming, printing, file transfer, or the like). These pieces of information are managed in relation to a public key described below by the smartphone 33. In a case where the camera 32 has joined a network, the smartphone 33 stores the information associated with the camera 32 in relation to identification information identifying the communication apparatus. These pieces of information are provided, as required, to another communication apparatus that joins the wireless network managed by the smartphone 33. This makes it possible for the communication apparatus joining the wireless network to know what apparatuses exit in the wireless network and which services are available.

The QR code displayed in F402 further includes information on a public key generated by the camera 32. A description of how this public key is used will be described later. After the camera 32 displays the QR code on the display unit 105, the camera 32 transmits a search signal for searching for a partner apparatus with which the communication parameter sharing process is to be performed (S503). In this specific example, a search signal is transmitted to search for the smartphone 33. As for this search signal, an action frame or a probe request defined in IEEE802.11 may be used. Note that the search signal includes a hash value of a public key included in the displayed QR code. Note that the search signal is transmitted in a different transmission method depending on the connection method specified in F401. For example, in a case where Wi-Fi Direct is specified in F401, that is, in a case where the QR code corresponding to the Wi-Fi Direct is displayed in F402, the search signal is transmitted by the method according to Wi-Fi Direct. More specifically, the search signal is transmitted only in particular channels (three channels of 1st, 6th, and 11th channels in the case of the 2.4 GHz band) sequentially from one channel to another as described above. On the other hand, in a case where it is specified in F402 to connect to an AP or operate as an AP, the search signal is transmitted over all channels (1st to 13th channels in the case of the 2.4 GHz band).

Thereafter, the camera 32 waits for a response signal to come in response to the search signal transmitted in S506 (F403). In a case where no response signal is received in a predetermined period of time after the transmission of the search signal, it is determined that the search process has failed, and the communication parameter sharing process is ended.

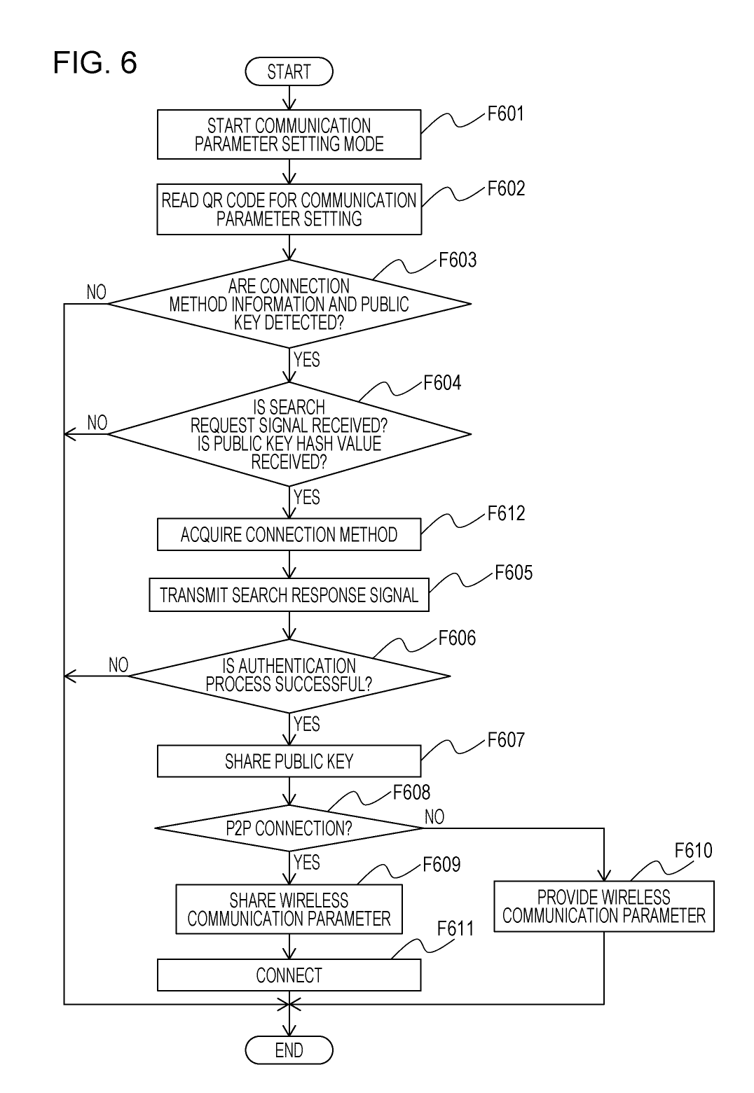

Next, the process performed by the smartphone 33 is described below with reference to a flow chart shown in FIG. 6. Steps of the flow chart are performed by the control unit 102 by executing a control program stored in the storage unit 103 of the smartphone 33. When the smartphone 33 accepts a command issued by a user to start the communication parameter setting mode, the smartphone 33 goes to a state in which the image capture unit 106 is enabled to capture an image (F601). Note that the smartphone 33 may be configured such that when the communication parameter setting mode is started, a user is prompted to select whether a QR code is displayed or an image of a QR code displayed on another apparatus is captured. In this specific example, it is assumed here that the user selects that the smartphone 33 is to capture an image of a QR code.

When the smartphone 33 has come to a state in which it is possible to capture an image, the smartphone 33 reads, using its image capture unit 106, the QR code displayed on the camera 32 (S502, F602). The smartphone 33 analyzes the read QR code to acquire information represented by the QR code. The smartphone 33 determines whether the information acquired from the QR code is information necessary to set communication parameters, and more specifically, in this case, whether the acquired information includes information associated with the connection method and the public key (F603). In a case where the QR code does not include information necessary to set communication parameters, the smartphone 33 may abort the process. In a case where the smartphone 33 determines that the QR code includes information necessary to set communication parameters, the smartphone 33 stores the connection method and the public key so as to be related to each other.

Next, the smartphone 33 waits, using the wireless communication unit 104, for a search signal to come from the camera 32. In this process, the smartphone 33 determines the connection method requested by the camera 32 based on the information acquired from the QR code in terms of the connection method. In a case where the connection method requested by the camera 32 is Wi-Fi Direct, the smartphone 33 performs the search process according to the Wi-Fi Direct standard described above. More specifically, the search process is performed while alternately switching the listen state and the search state such that waiting is performed in one of 1st, 6th, and 11th channels in the listen state and a search signal is transmitted only on 1st, 6th, and 11th channels in the search state. On the other hand, in a case where the connection method requested by the camera 32 is connecting to an AP or operating as an AP, the smartphone 33 waits for a search signal to come in a frequency channel in which the smartphone 33 is currently operating (for example, a channel of the wireless LAN network 31).

Next, the smartphone 33 determines whether the received search signal (S503) includes a hash value of a public key (F604), and compares this hash value with a hash value calculated from the stored public key. If the result of the comparison indicates that the two hash values are identical, then, based on connection methods stored in relation to the public key thereof, the smartphone 33 determines the connection method requested by an apparatus (the camera 32 in this specific example) that has transmitted the search signal (F612). In a case where the search signal does not include a hash value of the public key or in a case where the hash value included in the search signal is not equal to the hash value calculated from the stored public key, the smartphone 33 determines that the communication parameter sharing process has failed, and ends the process.

In F605, the smartphone 33 transmits a response signal in response to the search signal. If the smartphone 33 transmits the response signal and the camera 32 receives this response signal, then an authentication process is performed between the camera 32 and the smartphone 33 (F404, S505, F606). In this authentication process, a determination is performed as to whether the smartphone 33 is a valid apparatus with which the camera 32 is to perform the communication parameter sharing process. In the authentication process, a public key, used to encrypt the communication parameters and transmit the resultant encrypted communication parameters, is shared between the smartphone 33 and the camera 32 (F405, F607). Via the process described above, the camera 32 and the smartphone 33 are capable of sharing the public key. This public key is to be used in a communication process for sharing communication parameters.

In a case where Wi-Fi Direct is selected as the connection method, a role determination process, i.e., GO Negotiation is performed in S506 to determine which one of the camera 32 and the smartphone 33 operates as a GO or a CL. Note that in GO Negotiation, intent values are exchanged between apparatuses, and an apparatus having a larger intent value is assigned as a GO, while an apparatus having a smaller intent value is assigned as a CL. The apparatus assigned as the GO generates communication parameters. Alternatively, smartphone 33 may generate wireless communication parameters and provide them to GO. The apparatus that has generated the communication parameters is capable of encrypting the communication parameters using the public key shared in the above-described manner and providing the resultant encrypted communication parameters thereby allowing the communication parameters to be shared securely between the apparatuses (F409, S507, F609). The camera 32 and the smartphone 33 perform a wireless LAN connection process using the shared communication parameters (F410, S508, F611).

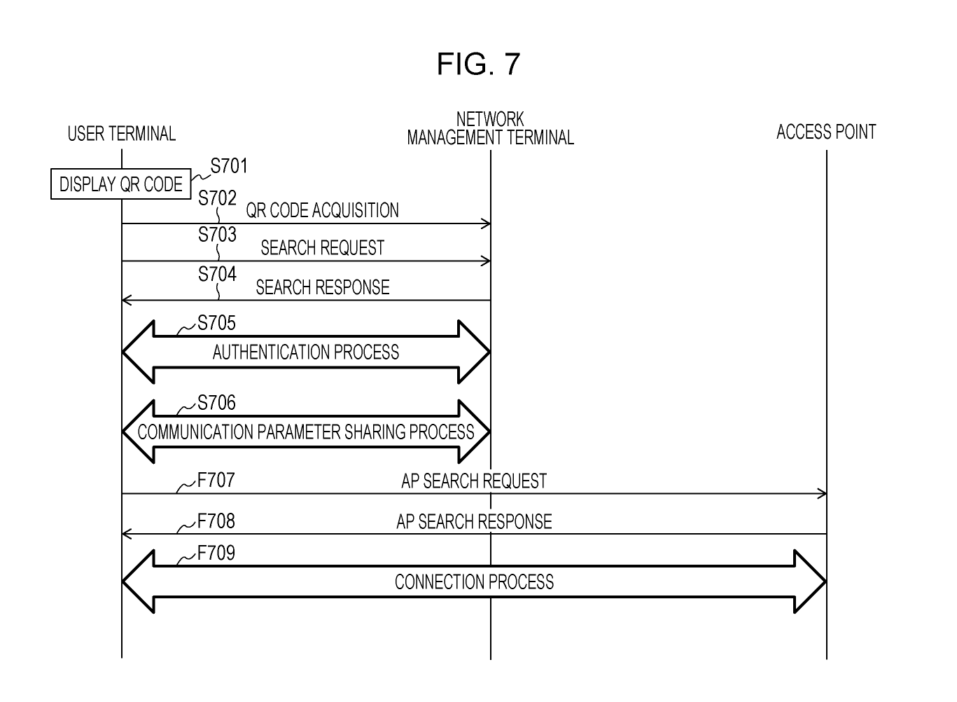

FIG. 7 is a sequence chart illustrating operations of respective communication apparatuses for a case where the camera 32 displays a QR code and selects connecting to an AP as the connection method. In FIG. 7, the smartphone 33 has communication parameters for the wireless network 31 created by the AP 34. When the camera 32 starts the communication parameter setting mode, the camera 32 displays, on the display unit 105, a screen to prompt a user to select one of “Wi-Fi Direct Connection, “Connect to AP”, “Operate as AP”. Herein, let it be assumed that the camera 32 receives a “Connect to AP” command via the input unit 109.

When the camera 32 accepts the command to connect to an AP, the camera 32 displays a QR code for connecting to an AP on the display unit 105 (S701). Here the QR code for connecting an AP is a QR code representing, in the coded form, information necessary to set communication parameters and information specifying “connect to AP”. The information specifying “connect to AP” may be information indicating an infrastructure mode defined in the IEEE802.11 standard.

The camera 32 and the smartphone 33 perform the search process, the authentication process, and the public key sharing process as described above. The smartphone 33 then encrypts the communication parameters necessary to connect to an AP using the shared public key, and provides them to the camera 32 (F413, F610, S706).

The camera 32 performs the process to connect to a wireless network created by an AP using the communication parameters acquired from the smartphone 33 (F414, S709).

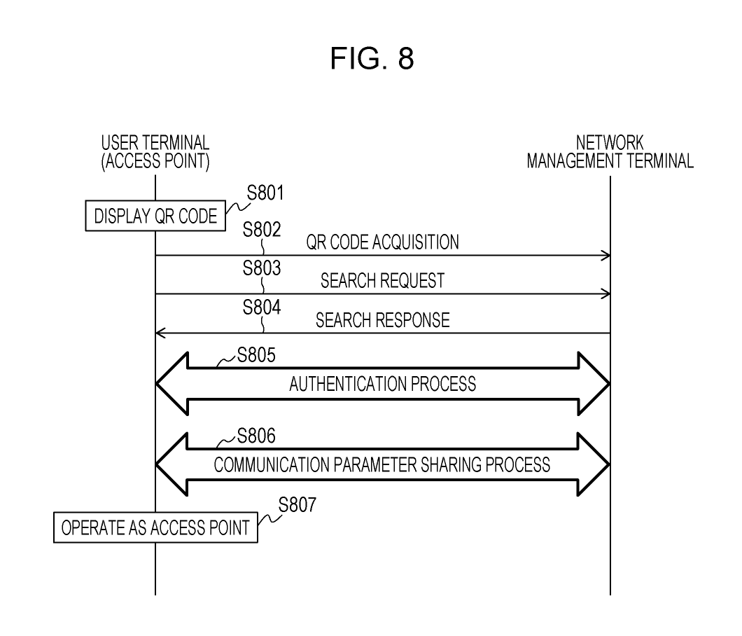

FIG. 8 is a sequence chart illustrating operations of respective communication apparatuses for a case where the camera 32 displays a QR code and selects operating as an AP as the connection method. In FIG. 8, the smartphone 33 has communication parameters for creating the wireless network 31.

On the other hand, when the camera 32 starts the communication parameter setting mode, the camera 32 displays, on the display unit 105, a screen to prompt a user to select one of “Wi-Fi Direct Connection, “Connect to AP”, and “Operate as AP”. Herein, let it be assumed that the camera 32 accepts, via the input unit 109, a command to “Operate as AP”.

When the camera 32 accepts the command to operate as an AP, the camera 32 displays a QR code for operating as an AP on the display unit 105 (S801). Note that the QR code for operating as an AP is a QR code representing, in the coded form, information necessary to set the communication parameters described above and information specifying “operate as an AP”.

The camera 32 and the smartphone 33 perform the search process, the authentication process, and the public key sharing process as described above. The smartphone 33 then encrypts the communication parameters necessary to operate as an AP using the shared public key, and provides them to the camera 32 (F411, F610, S806).

The camera 32 starts to operate as an AP using the received communication parameters and creates a wireless network (F414, S807).

According to the present embodiment, as described above, an apparatus, which displays a QR code, is capable of searching for a partner apparatus in an efficient manner depending on the selected connection method and sharing the communication parameters. An apparatus, which acquires the QR code by capturing an image thereof, performs searching or waits for being searched for according to the connection method requested by the apparatus that displays the QR codes, and thus it is possible to perform the communication parameter sharing process in an efficient manner.

### Other Embodiments

In the embodiments described above, information for setting communication parameters using an image of a QR code is transmitted between apparatuses. Alternatively, instead of capturing an image of a QR code, wireless communication such as Near Field Communication (NFC), Bluetooth (registered trademark), or the like may be used. Alternatively, wireless communication according to IEEE802.11ad or TransferJet (registered trademark) may be used.

The QR code to be read may be attached to a main body of a communication apparatus or a manual, or something accompanying a communication apparatus such as a cardboard case or other cases in which the communication apparatus is put when it is shipped. Alternatively, the QR code may be directly printed thereon. Instead of using a QR code, a one-dimensional barcode or a two-dimensional code other than the QR code may be used. Instead of using mechanically readable information such as a QR code, information readable by a user may be used.

In the embodiments described above, communication between apparatuses is performed by wireless LAN communication according to the IEEE802.11 standard. However, the communication method is not limited to this. For example, a wireless communication medium such as wireless USB, MBOA, Bluetooth, UWB, ZigBee, NFC, or the like may be used. Note that MBOA stands for Multi Band OFDM Alliance. The term UWB is used here to include wireless USB, wireless 1394, WINET and the like.

The present disclosure may also be practiced such that a program for realizing one or more functions described above is supplied to a system or an apparatus via a storage medium or a network, and, in the system or the apparatus, one or more processors read out the program and execute it. The present disclosure may also be practiced by a circuit (such as an ASIC) to realize one or more functions described above.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-144402, filed Jul. 21, 2015, which is hereby incorporated by reference herein in its entirety.

1. A communication apparatus comprising:
a selection unit configured to select one of a first connection method and a second connection method, the first connection method being a connection method in which a connection is made between the communication apparatus and a second different communication apparatus to acquire from the second different communication apparatus a communication parameter for use by an access point to create a wireless network, the second connection method being a connection method in which a role determination process is performed to determine whether the communication apparatus is to operate as an creating apparatus that is to create a wireless network or as a joining apparatus that is to join a created wireless network;
a display control unit configured to control a display unit to display an image including information indicating the connection method selected by the selection unit; and
a search unit configured to search for the second different communication apparatus such that in a case where the first connection method is selected by the selection unit, the second different communication apparatus is searched for on a plurality of channels usable by the communication apparatus, while in a case where the second connection method is selected by the selection unit, the second different communication apparatus is searched for on particular part of the plurality of channels,
wherein in the case where the first connection method is selected by the selection unit, the communication parameter for use by the access point to create the wireless network is acquired from the second different communication apparatus retrieved by the search unit, while in the case where the second connection method is selected by the selection unit, a communication parameter for wireless communication is shared between the communication apparatus and the second different communication apparatus retrieved by the search unit.

2. The communication apparatus according to claim 1, wherein the access point is an apparatus different from any one of the communication apparatus and the second different communication apparatus with which the communication apparatus performs the process by the first connection method.

3. The communication apparatus according to claim 1, wherein the access point is the communication apparatus.

4. A communication apparatus comprising:
an acquisition unit configured to acquire information associated with a second different communication apparatus from a captured image;
a determination unit configured to determine whether a connection method indicated by the information acquired by the acquisition unit is a first connection method or a second connection method, the first connection method being a connection method in which a connection is made between the communication apparatus and the second different communication apparatus to make the second different communication apparatus to acquire a communication parameter for use by an access point to create a wireless network, the second connection method being a connection method in which a role determination process is performed to determine whether the communication apparatus operates as an creating apparatus that creates a wireless network or as a joining apparatus that joins a created wireless network, and
a control unit configured to perform control such that in a case where the determination unit determines that the connection method is the first connection method, the communication apparatus waits for a search signal transmitted from the second different communication apparatus to come in a predetermined channel in which the communication apparatus operates, while in a case where the determination unit determines that the connection method is the second connection method, the communication apparatus searches for the second different communication apparatus in particular part of a plurality of channels usable by the communication apparatus,
wherein in the case where the determination unit determines that the connection method is the first connection method, the communication parameter for use by the access point to create the wireless network is provided to the second different communication apparatus that has transmitted the search signal on the predetermined channel, while in the case where the determination unit determines that the connection method is the second connection method, a communication parameter for wireless communication is shared between the communication apparatus and the retrieved second different communication apparatus.

5. The communication apparatus according to claim 4, wherein the access point is the second different communication apparatus that has transmitted the search signal on the predetermined channel.

6. The communication apparatus according to claim 4, further comprising an image capture unit configured to capture an image,
wherein the acquisition unit acquires information associated with the second different communication apparatus by analyzing the image captured by the image capture unit.

7. The communication apparatus according to claim 1, wherein the image includes one of a barcode and a two-dimensional code.

8. The communication apparatus according to claim 1, wherein the first connection method is a connection method in an infrastructure mode according to the IEEE802.11 standard.

9. The communication apparatus according to claim 1, wherein the second connection method is a connection method in which particular part of channels are for the Wi-Fi Direct connection.

10. The communication apparatus according to claim 1, wherein the communication parameter includes at least one of an SSID, an encryption key, an encryption method, an authentication key, and an authentication method.

11. The communication apparatus according to claim 1, wherein the communication parameter is information for performing communication according to the IEEE802.11 standard.

12. A communication method comprising:
selecting one of a first connection method and a second connection method, the first connection method being a connection method in which a connection is made between a first communication apparatus and a second communication apparatus to acquire, from the first communication apparatus, a communication parameter for use by an access point to create a wireless network, the second connection method being a connection method in which a role determination process is performed to determine whether each of the first communication apparatus and the second communication apparatus is to operate as an creating apparatus that it to create a wireless network or as a joining apparatus that is to join the created wireless network;
displaying an image including information indicating the selected connection method on a display unit; and
searching for the first communication apparatus such that in a case the first connection method is selected, the first communication apparatus is searched for on a plurality of channels usable by the second communication apparatus, while in a case where the second connection method is selected, the first communication apparatus is searched for on particular part of the plurality of channels,
wherein in the case where the first connection method is selected, the communication parameter for use by the access point to create the wireless network is acquired from the retrieved first communication apparatus, while in the case where the second connection method is selected, a communication parameter for wireless communication is shared between the retrieved first communication apparatus and the second communication apparatus.

13. A communication method comprising:
acquiring information associated with a first communication apparatus from a captured image;
determining whether a connection method indicated by the acquired information is a first connection method or a second connection method, the first connection method being a connection method in which a connection is made between the first communication apparatus and a second communication apparatus in order for the first communication apparatus to acquire a communication parameter for use by an access point to create a wireless network, the second connection method being a connection method in which a role determination process is performed to determine whether each of the first communication apparatus and the second communication apparatus is to operate as an creating apparatus that creates a wireless network or as a joining apparatus that is to join the created wireless network; and
performing control such that in a case where it is determined that the connection method is the first connection method, the second communication apparatus waits for a search signal transmitted from the first communication apparatus to come in a particular channel in which the second communication apparatus operates, while in a case where it is determined that the connection method is the second connection method, the second communication apparatus searches for the first communication apparatus in particular part of a plurality of channels usable by the second communication apparatus,
wherein in a case where it is determined that the connection method is the first connection method, the communication parameter for use by the access point to create the wireless network is provided to the first communication apparatus that has transmitted the search signal on the predetermined channel, while in a case where it is determined that the connection method is the second connection method, a communication parameter for wireless communication is shared between the retrieved first communication apparatus and the second communication apparatus.

14. A non-transitory computer-readable storage medium storing a computer program for causing a computer to function as:
a selection unit configured to select one of a first connection method and a second connection method, the first connection method being a connection method in which a connection is made between the communication apparatus and a second different communication apparatus to acquire from the second different communication apparatus a communication parameter for use by an access point to create a wireless network, the second connection method being a connection method in which a role determination process is performed to determine whether the communication apparatus is to operate as an creating apparatus that is to create a wireless network or as a joining apparatus that is to join a created wireless network;
a display control unit configured to control a display unit to display an image including information indicating the connection method selected by the selection unit; and
a search unit configured to search for the second different communication apparatus such that in a case where the first connection method is selected by the selection unit, the second different communication apparatus is searched for on a plurality of channels usable by the communication apparatus, while in a case where the second connection method is selected by the selection unit, the second different communication apparatus is searched for on particular part of the plurality of channels,
wherein in the case where the first connection method is selected by the selection unit, the communication parameter for use by the access point to create the wireless network is acquired from the second different communication apparatus retrieved by the search unit, while in the case where the second connection method is selected by the selection unit, a communication parameter for wireless communication is shared between the communication apparatus and the second different communication apparatus retrieved by the search unit.

15. The communication apparatus according to claim 1, wherein the image includes one of a barcode and a two-dimensional code.

16. The communication apparatus according to claim 1, wherein the first connection method is a connection method in an infrastructure mode according to the IEEE802.11 standard.

17. The communication apparatus according to claim 1, wherein the second connection method is a connection method in which particular part of channels are for the Wi-Fi Direct connection.

18. The communication apparatus according to claim 1, wherein the communication parameter includes at least one of an SSID, an encryption key, an encryption method, an authentication key, and an authentication method.

19. The communication apparatus according to claim 1, wherein the communication parameter is information for performing communication according to the IEEE802.11 standard.

20. A non-transitory computer-readable storage medium storing a computer program for causing a computer to function as:
an acquisition unit configured to acquire information associated with a second different communication apparatus from a captured image;
a determination unit configured to determine whether a connection method indicated by the information acquired by the acquisition unit is a first connection method or a second connection method, the first connection method being a connection method in which a connection is made between the communication apparatus and the second different communication apparatus to make the second different communication apparatus to acquire a communication parameter for use by an access point to create a wireless network, the second connection method being a connection method in which a role determination process is performed to determine whether the communication apparatus operates as an creating apparatus that creates a wireless network or as a joining apparatus that joins a created wireless network, and
a control unit configured to perform control such that in a case where the determination unit determines that the connection method is the first connection method, the communication apparatus waits for a search signal transmitted from the second different communication apparatus to come in a predetermined channel in which the communication apparatus operates, while in a case where the determination unit determines that the connection method is the second connection method, the communication apparatus searches for the second different communication apparatus in particular part of a plurality of channels usable by the communication apparatus,
wherein in the case where the determination unit determines that the connection method is the first connection method, the communication parameter for use by the access point to create the wireless network is provided to the second different communication apparatus that has transmitted the search signal on the predetermined channel, while in the case where the determination unit determines that the connection method is the second connection method, a communication parameter for wireless communication is shared between the communication apparatus and the retrieved second different communication apparatus.
